(19) United States
(12) Patent Application Publication
(10) Pub. No.: US 2021/0394859 A1
(43) Pub. Date: Dec. 23, 2021

(54) BICYCLE HANDLEBAR MODULE COMBINING BRAKE LEVERS AND DERAILLEUR SHIFTER CONTROL DEVICES

(71) Applicant: IWEI CHEN, Changhua County (TW)

(72) Inventor: IWEI CHEN, Changhua County (TW)

(21) Appl. No.: 17/341,401

(22) Filed: Jun. 8, 2021

(30) Foreign Application Priority Data
Jun. 18, 2020 (TW) 109120506

(51) Int. Cl. B62K 21/16; B62K 23/06; B62J 6/028; B62L 3/02; B62M 25/04

(52) U.S. Cl. CPC B62K 21/16; B62K 23/06; B62M 25/04; B62L 3/02; B62J 6/028

(57) ABSTRACT

A bicycle handlebar module combining brake levers and derailleur shifter control devices comprises a bicycle handlebar, two brake levers, and two derailleur shifter control devices, two ends of the bicycle handlebar are respectively formed with a grip part, and a front side of the bicycle handlebar near each of the two ends is respectively formed with a pivoting part and an accommodating part, the two brake levers are pivotally connected to the two pivoting parts with one end respectively, the brake levers are exposed on the front side of the bicycle handlebar, and the two derailleur shifter control devices are respectively disposed in the accommodating parts of the bicycle handlebar; thereby, the bicycle handlebar, the brake levers and the two derailleur shifter control devices jointly form a modular structure, and thus achieving an object of modular production and modular sales.

### BACKGROUND OF THE INVENTION

### Field of Invention

The invention relates to a bicycle handlebar module combining brake levers and derailleur shifter control devices, in which the brake levers and the derailleur shifter control devices are combined with a bicycle handlebar to form a three-in-one modular structure.

### Description of Related Art

Since bicycle has a large number of various parts and components that have standard specifications, the bicycle industry has formed a huge industrial supply chain over time. After professional production of various bicycle parts and components, they are sent to professional assembly factories for assembling externally and delivery, among the main parts and components, such as the derailleur shifter control device in the transmission, the brake lever, the bicycle lamp and the direction lamp, etc. must be assembled on the bicycle handlebar. However, it has the following drawbacks: each of the parts and components must be connected with other accessories such as protective shell, joint, pivoting part or connector, etc., in order to have a complete finished appearance and structural design. After the parts and components are sent to assembly factories, the above-mentioned accessories are directly and exposedly assembled on the other parts and components of a bicycle. Therefore, there are too many joints, pivoting parts and connectors connected between the various parts and components of the bicycle, which not only make the assembly process complicated and time-consuming, but also increase the assembly cost, which indirectly lead to high cost of the bicycle as a whole. Thus, how to research and improve to tackle the above-mentioned problems by assembling with modular structures in order to effectively reduce the assembly time and assembly cost is indeed an object the relevant industries need to endeavor to achieve.

### SUMMARY OF THE INVENTION

The invention is invented in view of the above-mentioned drawbacks, a main object of the invention is to provide a bicycle handlebar module combining brake levers and derailleur shifter control devices, comprising: a bicycle handlebar, two ends of the bicycle handlebar are respectively formed with a grip part, and a front side of the bicycle handlebar near each of the two ends is respectively formed with a pivoting part and an accommodating part; two brake levers pivotally connected to the two pivoting parts with one end respectively, and the brake levers are exposed on the front side of the bicycle handlebar; and two derailleur shifter control devices respectively disposed in the accommodating parts of the bicycle handlebar, wherein the derailleur shifter control device at least comprises a gear shift mechanism, a cable, a tension mechanism, and a release mechanism, the tension mechanism and the release mechanism are linked to rotation of the gear shift mechanism, the gear shift mechanism is connected to one end of the cable, the tension mechanism is capable of controlling to tension the cable by rotation of the gear shift mechanism, and the release mechanism is capable of controlling to release the cable by rotation of the gear shift mechanism, when the derailleur shifter control device is installed in the bicycle handlebar, the tension mechanism and the release mechanism are exposed outside the bicycle handlebar.

Efficacies of the Invention are:

The invention is capable of directly assembling the two brake levers, the derailleur shifter control devices, direction lamps, a front lamp and other parts and components on the bicycle handlebar to complete a modular assembly of the invention. Therefore, it can not only save assembly time and assembly cost, but also indirectly reduce an overall bicycle cost.

### BRIEF DESCRIPTION OF THE DRAWINGS

FIG. 1 is a perspective assembly view of a first embodiment of the invention;

FIG. 2 is an exploded perspective view of FIG. 1;

FIG. 3 is a side view of FIG. 1; and

FIG. 4 is a perspective assembly view of a second embodiment of the invention.

### DETAILED DESCRIPTION OF THE INVENTION

In order to enable the examiner to further have a better understanding and recognition of the object, features and efficacies of the invention, please refer to the following detailed description of the preferred embodiments with reference to the drawings.

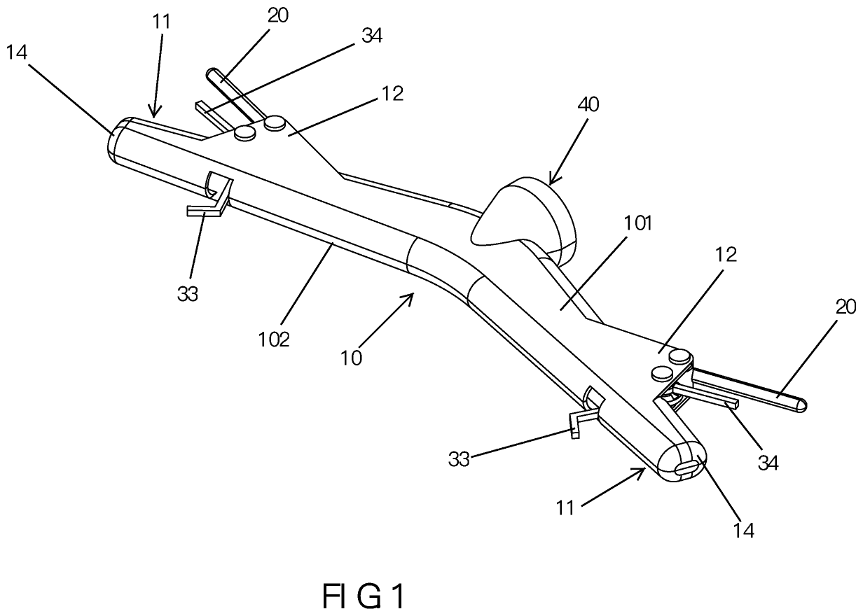

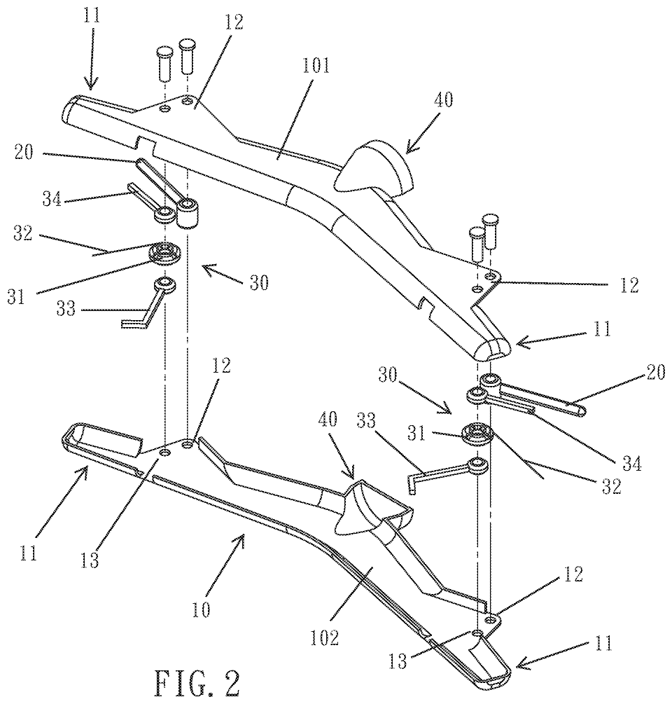

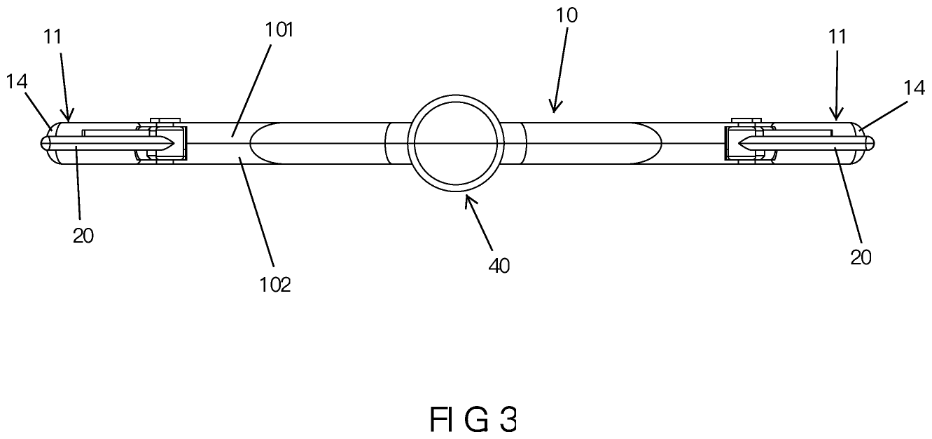

Please refer to FIGS. 1 to 3. The invention provides a bicycle handlebar module combining brake levers and derailleur shifter control devices, comprising:

a bicycle handlebar 10, two ends of the bicycle handlebar 10 are respectively formed with a grip part 11, and a front side of the bicycle handlebar 10 near each of the two ends is respectively formed with a pivoting part 12 and an accommodating part 13, in addition, a front center of the bicycle handlebar 10 is provided with a front lamp 40;

two brake levers 20 pivotally connected to the two pivoting parts 12 with one end respectively, and the brake levers 20 are exposed on the front side of the bicycle handlebar 10; and

two derailleur shifter control devices 30 respectively disposed in the accommodating parts 13 of the bicycle handlebar 10, wherein the derailleur shifter control device 30 at least comprises a gear shift mechanism 31, a cable 32, a tension mechanism 33, and a release mechanism 34, the tension mechanism 33 and the release mechanism 34 are linked to rotation of the gear shift mechanism 31, the gear shift mechanism 31 is connected to one end of the cable 32, the tension mechanism 33 is capable of controlling to tension the cable 32 by rotation of the gear shift mechanism 31, and the release mechanism 34 is capable of controlling to release the cable 32 by rotation of the gear shift mechanism 31, when the derailleur shifter control device 30 is installed in the bicycle handlebar 10, the tension mechanism 33 and the release mechanism 34 are exposed outside the bicycle handlebar 10.

Wherein, the bicycle handlebar 10 is in a shape of the letter v.

Wherein, the bicycle handlebar 10 can be formed by combining an upper cover 101 and a lower cover 102.

Wherein, the two ends of the bicycle handlebar 10 are provided with a direction lamp 14 respectively.

Wherein, the bicycle handlebar 10 can be folded at a center as a fulcrum.

With the above-mentioned structure and composition design, a way in which the invention is assembled is described as follows:

(1) As shown in a first embodiment in FIGS. 1 to 3, after the two brake levers 20 and the two derailleur shifter control devices 30 are assembled into the lower cover 102 of the bicycle handlebar 10, the upper cover 101 of the bicycle handlebar 10 covers the lower cover 102, the brake levers 20 are exposed on the front side of the bicycle handlebar 10, the tension mechanisms 33 are exposed on a rear side of the bicycle handlebar 10, and the release mechanisms 34 are exposed on the front side of bicycle handlebar 10.

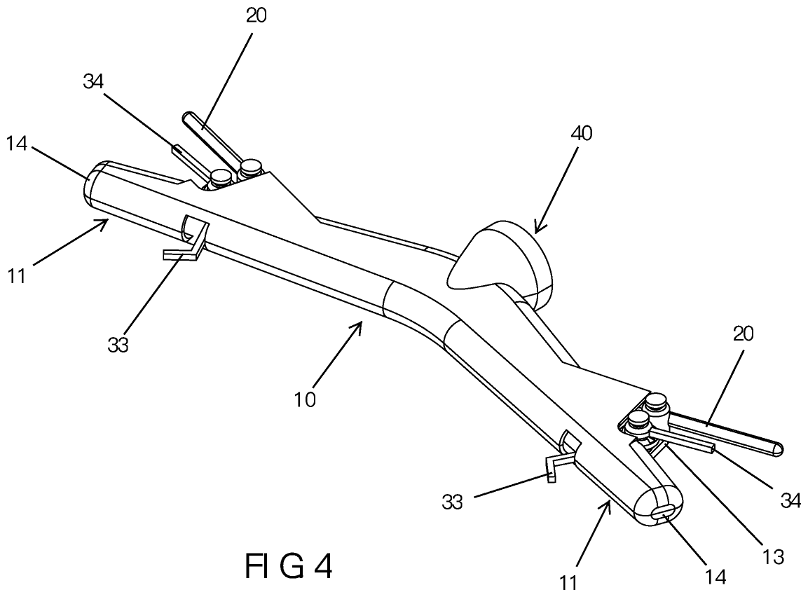

(2) As shown in a second embodiment in FIG. 4, the bicycle handlebar 10 is integrally formed, the pivoting parts 12 and the accommodating parts 13 are in a form of an upward hollow structure, and then the two brake levers 20 and the two derailleur shifter control devices 30 are directly assembled on the pivoting parts 12 and the accommodating parts 13 of the bicycle handlebar 10 respectively to complete the assembly of the invention.

With the structure of the above specific embodiments, the following effectiveness can be obtained:

The invention is capable of removing the original connectors, bases, and shells required for connecting the brake levers, derailleur shifter control devices, front lamp, and direction lamps to the bicycle handlebar, and the above-mentioned parts and components of bases, and shells are directly integrated on the bicycle handlebar 10 of the invention, and then the two brake levers 20, the gear shift mechanisms 31, the cables 32, the tension mechanisms 33, the release mechanisms 34, the direction lamps 14 and the front lamp 40 are assembled with the bicycle handlebar 10 to complete the modular assembly of the invention. Therefore, it can not only save assembly time and assembly cost, but also indirectly reduce the overall bicycle cost.

In summary, the invention is capable of effectively solving the drawbacks of the prior art, and can be easily understood and implemented by those having ordinary skill in the art to which the invention pertains. However, the above description is only the preferred embodiments of the invention, and should be construed as exemplary rather than as limitative of the invention, with many variations and modifications being readily attainable by a person of average skill in the art without departing from the spirit or scope thereof as defined by the appended claims and their legal equivalents.

What is claimed is:

1. A bicycle handlebar module combining brake levers and derailleur shifter control devices, comprising:
a bicycle handlebar, two ends of the bicycle handlebar being respectively formed with a grip part, and a front side of the bicycle handlebar near each of the two ends being respectively formed with a pivoting part and an accommodating part; and
two brake levers pivotally connected to the two pivoting parts with one end respectively, and the brake levers being exposed on the front side of the bicycle handlebar.

2. The bicycle handlebar module combining the brake levers and the derailleur shifter control devices as claimed in claim 1, wherein the accommodating part is disposed with a derailleur shifter control device, the derailleur shifter control device at least comprises a gear shift mechanism, a cable, a tension mechanism, and a release mechanism, the tension mechanism and the release mechanism are linked to rotation of the gear shift mechanism, the gear shift mechanism is connected to one end of the cable, the tension mechanism is capable of controlling to tension the cable by rotation of the gear shift mechanism, and the release mechanism is capable of controlling to release the cable by rotation of the gear shift mechanism, when the derailleur shifter control device is installed in the bicycle handlebar, the tension mechanism and the release mechanism are exposed outside the bicycle handlebar.

3. The bicycle handlebar module combining the brake levers and the derailleur shifter control devices as claimed in claim 1, wherein the bicycle handlebar is in a shape of the letter v.

4. The bicycle handlebar module combining the brake levers and the derailleur shifter control devices as claimed in claim 1, wherein the bicycle handlebar is formed by combining an upper cover and a lower cover.

5. The bicycle handlebar module combining the brake levers and the derailleur shifter control devices as claimed in claim 1, wherein a front center of the bicycle handlebar is provided with a front lamp.

6. The bicycle handlebar module combining the brake levers and the derailleur shifter control devices as claimed in claim 1, wherein the bicycle handlebar can be folded at a center as a fulcrum.

7. The bicycle handlebar module combining the brake levers and the derailleur shifter control devices as claimed in claim 1, wherein the two ends of the bicycle handlebar are provided with a direction lamp respectively.
